(19) United States
(12) Patent Application Publication
(10) Pub. No.: US 2008/0202851 A1
(43) Pub. Date: Aug. 28, 2008

(54) LADDER ANTI-FALL DEVICE

(76) Inventors: Donald R. Schwenke, Acton, CA (US); Michael R. Cinquemani, Acton, CA (US); James Charles Forbes, Acton, CA (US)

Correspondence Address: LAWRENCE S. COHEN, ESQ.;LAW OFFICE OF LAWRENCE S. COHEN, 10960 WILSHIRE BLVD, SUITE 1220, LOS ANGELES, CA, 90024, US

(21) Appl. No.: 12/025,726

(22) Filed: Feb. 4, 2008

Related U.S. Application Data
(60) Provisional application No. 60/899,224, filed on Feb. 2, 2007.

(51) Int. Cl. E06C 7/06

(52) U.S. Cl. 182/107

(57) ABSTRACT

Described is a ladder safety device for use with non supported ladders and methods of using such a device. The device has a cross bar and hooks extending from it. The hooks will engage the rails or a rung of the ladder and hold the cross bar tightly against the ladder rails. Legs extend in the opposite direction with feet that will sit on the structure which is commonly a roof, but could also be any structure in which a ladder extends beyond a support line.

### RELATED APPLICATIONS

This application is related to Provisional Application No. 60/899,224 filed on Feb. 2, 2007 the content of which is incorporated by reference herein and the benefit of that filing date is claimed for this application.

### FIELD OF THE INVENTION

The invention is in the field of safety devices for ladders.

### BACKGROUND

The problem of ladder safety is serious. Two types of ladder accidents are “fall-back” in which the ladder will rotate away from the structure, pivoting on its feet on the ground and “kick-out” in which the ladder feet slip away from the structure. Ladders also can tilt sideways, laterally to their height.

A common ladder use is to access a roof or other platform such as a balcony. In these applications the ladder typically leans against the platform at a horizontal line in the structure such as a roof eave line, and extends upward beyond the point of contact preferably by at least three feet. It can also lean against an angles contact line such as a roof rake. In some cases it will be against a parapet wall.

A very common activity is roofing repair and replacement in which a ladder may be put in place and used over many hours of work.

Accidents in this type of ladder application, due to unintended movement of the ladder continue to be too common.

There are numerous safety standards for ladders such as OSHA standards in 29 CFR 1910.26 and 29 CFR 1926.1053 and ANSI standards A14. These federal standards, as well as numerous state standards for ladder safety address numerous general and specific regulations for the construction, use and maintenance of ladders.

Nevertheless there continues to be a large number of accidents from the use of ladders.

The present invention addresses one type of problem which is the inadvertent movement of ladders which lean against a roof line at eaves or along a rake or a parapet wall, or a landing or balcony or any similar structure in which the ladder extends above the structure against which it is leaning.

### BRIEF DESCRIPTION OF THE DRAWINGS

FIG. 1 shows a bottom assembly view of an embodiment of the invention.

FIG. 2 shows a perspective view of an embodiment of the invention.

FIG. 3 shows a section view along the line 3-3 of FIG. 1.

FIG. 4 shows a perspective view of a slide block as shown in FIG. 2.

FIG. 5 shows a perspective view of a slide block as shown in FIG. 2 along with a hook.

FIG. 6 shows a partial view showing the device in place on a ladder rail with a hook around the rail.

FIG. 7 shows a partial view showing the ladder angle bubble level on the cross bar of the invention.

FIG. 8 shows how the invention is used to set a ladder at a correct angle and also how the invention is installed on a ladder and a surface structure.

FIG. 9 shows how the invention is used to set a ladder at a correct angle and also how the invention is installed on a ladder and a pitched roof.

FIG. 10 shows how the invention is used to set a ladder at a correct angle and also how the invention is installed on a ladder and a flat roof.

FIG. 11 shows how the invention is used to set a ladder at a correct angle and also how the invention is installed on a ladder and a parapet.

FIG. 12 shows the invention installed as articulated on a ladder onto a roof rake.

FIG. 13 shows a perspective view of an extendable leg assembly.

FIG. 14 shows a perspective exploded view of an extendable leg assembly.

FIG. 15 shows how an extendable leg assembly can be used.

FIG. 16 shows an extendable leg assembly with a right angle leg extension in place on a ladder and a parapet.

FIG. 17 shows a perspective view of a leg extension assembly with a right angle leg extension.

FIG. 18 shows a perspective exploded view of a leg extension assembly with a right angle leg extension.

FIGS. 19A, 19B, and 19C show views of a leg extension slide block.

FIG. 20 shows a partial view of the invention installed on a ladder with the hooks on the rails.

FIG. 21 shows a partial view of the invention installed on a ladder with the hooks on a rung.

FIG. 22 shows a view of the invention with a ladder against a pitched roof and the hooks on a rung.

FIG. 23 shows a view of the invention installed on a ladder using a single hook on a rung.

FIG. 24 shows a section view of 24-24 of FIG. 23.

FIG. 25 shows a partial exploded top view of an embodiment of the invention.

FIG. 26 shows a front view of the cross bar of an embodiment of the invention.

FIG. 27 shows a partial top view of the cross bar of an embodiment of the invention.

FIG. 28 shows a partial front view of the cross bar of an embodiment of the invention.

FIGS. 29A, 29B, and 29C show views of an embodiment of the feet of the invention.

FIG. 30 shows an installation of an embodiment of the invention in moderately articulated position on a roof rake.

FIG. 31 shows an installation of an embodiment of the invention in severely articulated position on a roof rake.

FIG. 32 shows a partial exploded top view of an embodiment of the invention.

FIG. 33 shows a partial view of the embodiment of FIG. 32 installed on a ladder rail.

FIG. 34 shows a sectional view of the embodiment of FIG. 32 installed on a ladder rail.

FIG. 35 shows a perspective view of a double slotted embodiment of the invention installed offset on a ladder.

FIG. 36 shows the invention in use on a ladder and a pitched roof.

### DETAILED DESCRIPTION

The present invention called the “SAFE T CLIMB LADDER ANTI-FALL DEVICE” is a ladder attachment (“device”) that prevents ladder “fall-back,” “kick-out” due to incorrect or uneven ladder placement. It also prevents a ladder from tilting laterally. The device attaches to any extension ladder in approximately 10 seconds. More generally, the type of ladder is referred to as non-self supporting ladders. Ladder manufacture and use is regulated by OSHA Regulations Standard Numbers 1926.1053 (29 CFR 1926.1053) and 1910.26 (29 CFR 1910.26). In particular the OSHA regulation requires that non-self-supporting ladders be used at an angle of 75.5°. This is also called the 1,4 rules because of its description in OSHA Standard Number 1926.1053(b)(5)(i). The Regulations also provide that under certain usage conditions ladders “shall be secured to prevent accidental displacement” (Standard Number 1926.1053(b)(8)).

The present invention is used with non-self-supporting ladders that are used such that the top support is a non vertical structure. Most commonly the invention is used when the ladder is supported against a roof line. But it can also be used when the top support is any other structure in which the ladder extends above the top support such as balconies and landings. In most cases the top support is horizontal or nearly horizontal, although the invention can also be used when the top support points for the ladder rails are at a different height, such as along a roof rake line. The general description of all uses of the invention are under the condition that the ladder rails contact a support point and extend beyond the support point.

A convenient bubble level offset can be incorporated into the device so that when placed parallel against either the rungs or side rail of a ladder placed on the edge of a building it will assist in properly adjusting the ladder by indicating level placement via a bubble level when the ladder is approximately 75.5 degrees. The 75.5 degree angle setup meets OSHA requirements (29 CFR 1926 Section 1926.1053) for correct ladder angle to prevent fall-back or kick-out. Although the OSHA standard is 75.5° it is common in the industry to refer to it as approximately 75°, and that terminology will be used herein.

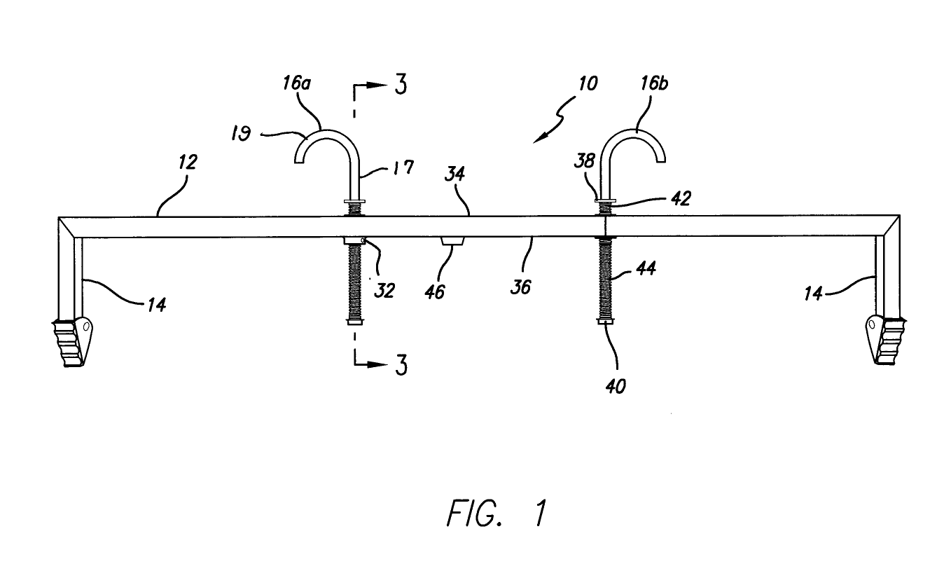

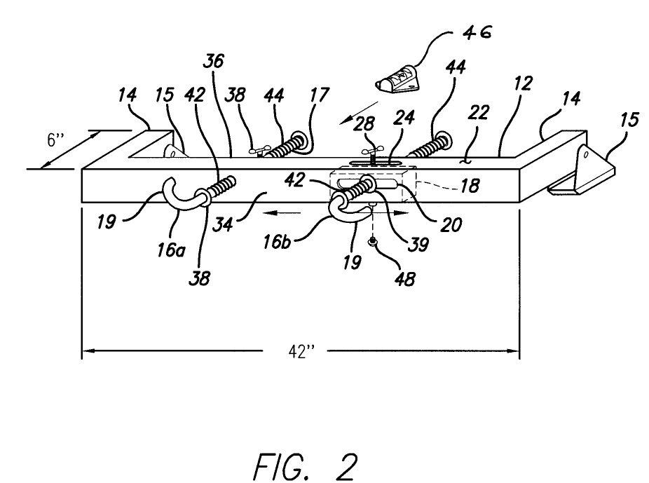

In one embodiment, as seen in FIG. 1, the invention is about 42 inches long with two legs (each approximately 6 inches long) each attached to a ladder foot or similar device. The feet swivel to allow for contact to any roof pitch or other surface. FIG. 2 shows a perspective view of an embodiment of the invention.

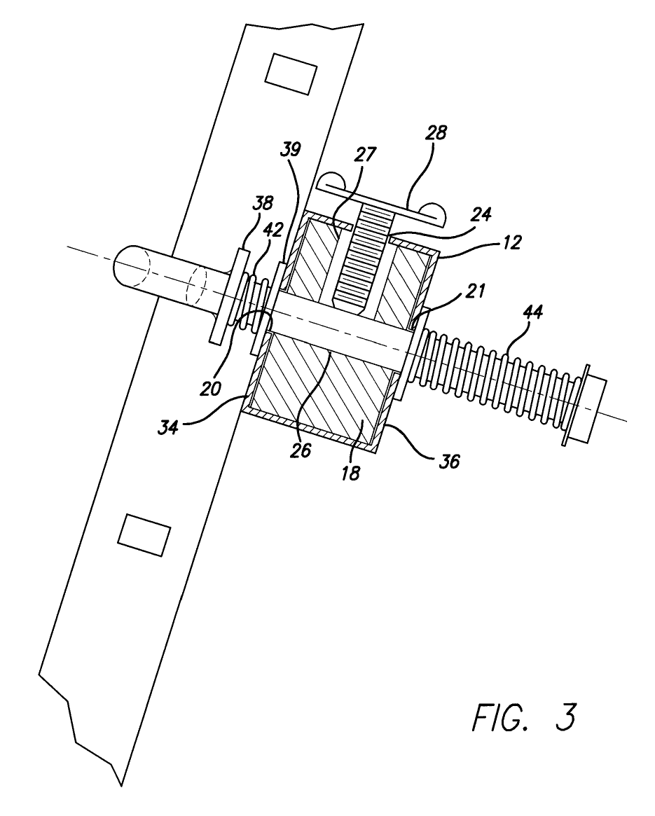

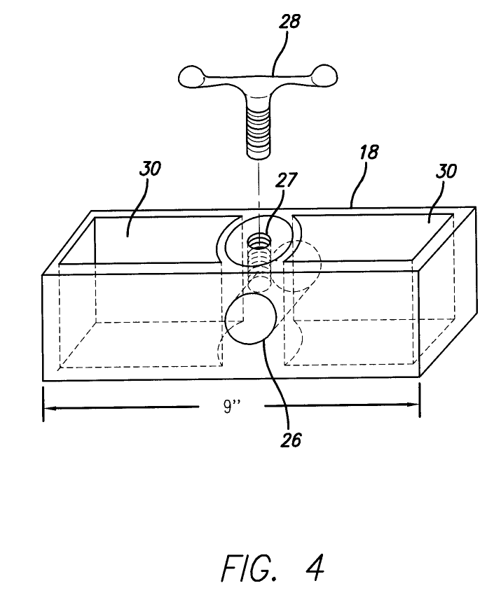

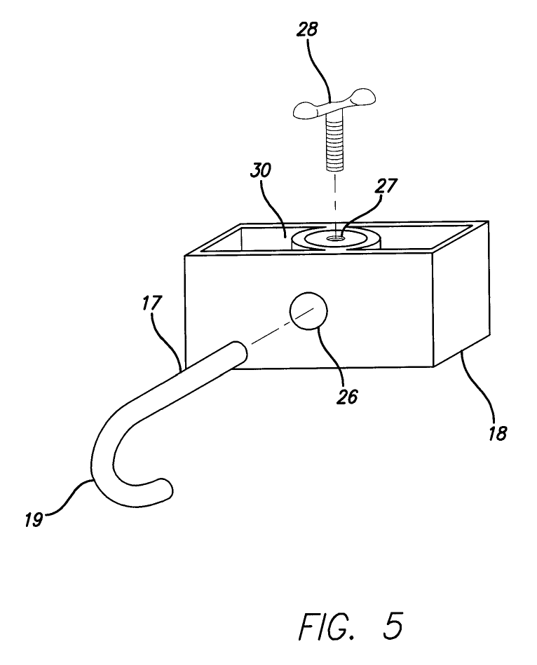

FIG. 1 shows a bottom view and of the device and FIG. 3 shows a section through 3-3 of FIG. 1 and FIG. 2 shows a perspective view. In this embodiment the device 10 has a cross bar 12 made of a steel box section, in the exemplary case 16 gauge steel, 1 inch by 1.5 inch. At the ends of the crossbar 12, legs 14 are attached, in the exemplary case by welding. At the end of the legs 14 are swiveling feet 15; in the exemplary case ladder feet are installed. Construction of the cross bar and legs can be done in various ways including for example; one piece being bent at the ends to form the legs; or it can be made out of fiberglass (to render it non-conductive) with the legs integral to the cross bar or regardless of material the legs can be attached to the cross bar by a fastening mechanism; it can be made from several parts assembled together. The device 10 further comprises a pair of hooks 16a and 16b extending through the cross bar 12, in the exemplary case made of ½ inch steel rod. Detail of construction and installation of the hooks 16a and 16b are shown in FIGS. 2, 3, 4, and 5. The hooks 16a and 16b are of the same construction, but are installed to face oppositely to attach to a rail of the ladder respectively. Each of the hooks 16a and 16b has a straight portion 17 and a curved portion 19. At the location in the cross bar 12 where the hook 16b passes through it, there are slots 20 and 21 and on the top surface 22 of the cross bar is a slot 24. Referring to FIGS. 2, 3, 4, and 5, inside the cross bar 12 adjacent to the slots 20, 21 and 24 is a slide block 18. As can be seen in FIGS. 4 and 5 the slide block 18 has a horizontal through hole 26 and a threaded insert 27 that intersects the horizontal through hole 26. In the threaded insert 27 is a wing screw 28. The hook 16b, extends through the through hole 26.

For manufacturing, to avoid warpage, when the slide block 18 is cast from plastic, it preferably has a cavity or hollow area 30. However the slide block 18 can be made of any material such as aluminum; in which case the threaded insert may be avoided by threading the aluminum.

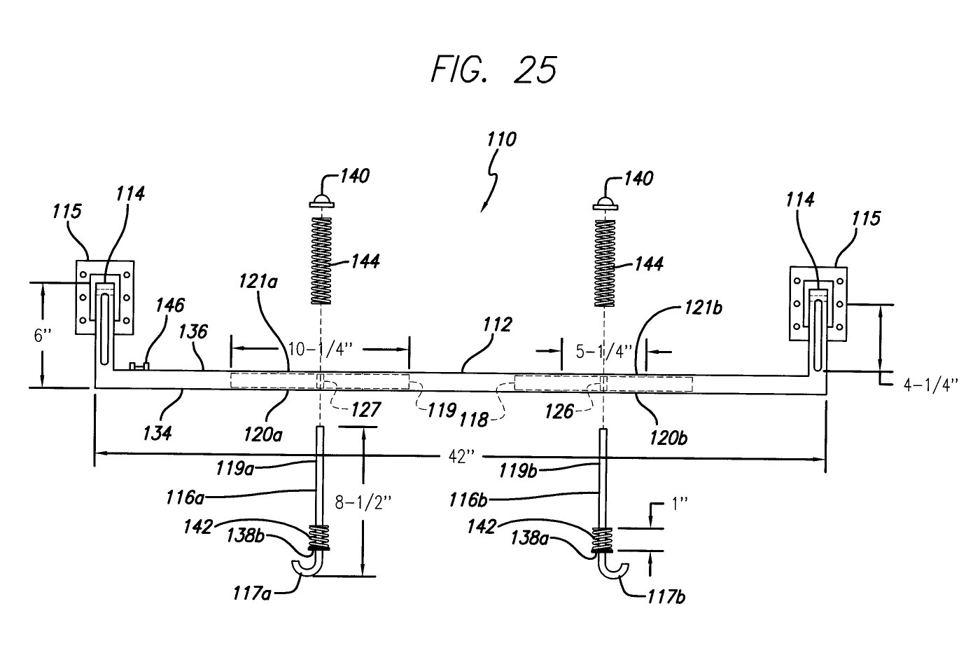

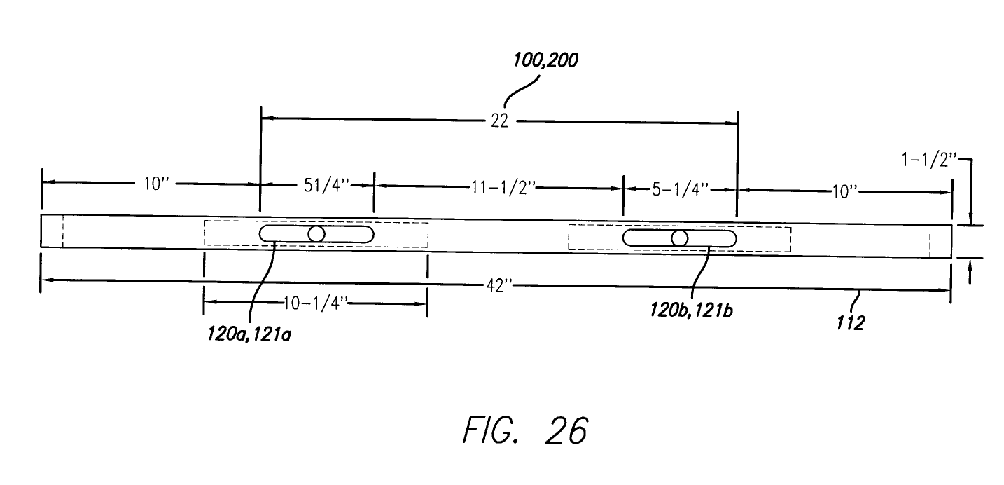

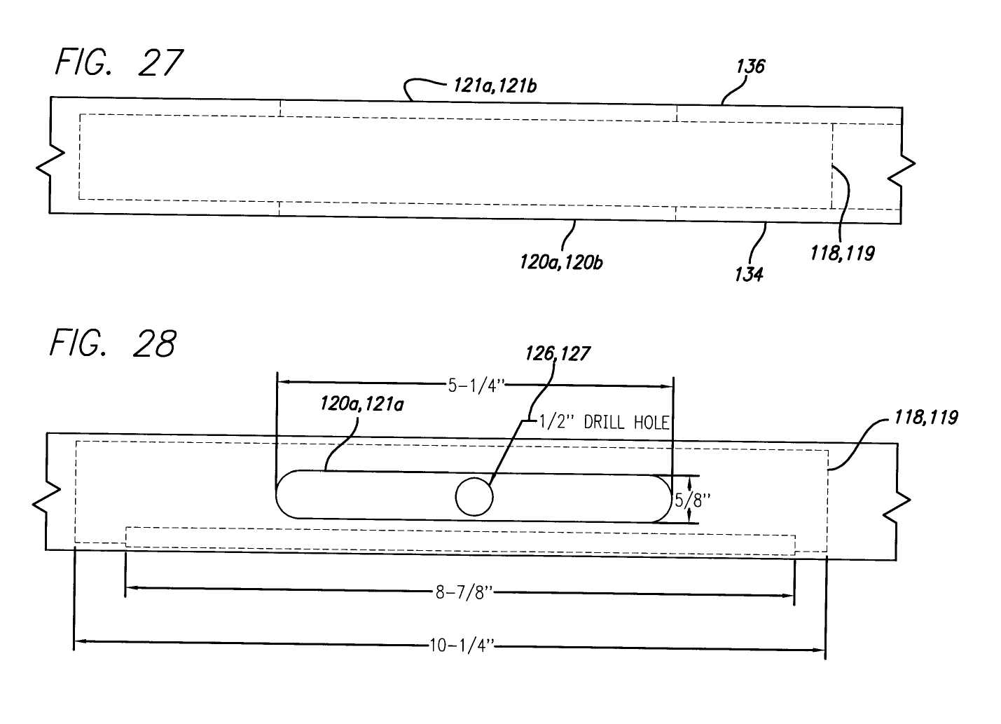

Referring to FIGS. 1, 2 and 3, the hook 16b extends through the cross bar 12 passing through the slots 20 and 21, and through the horizontal through hole 26 in the slide block 18. For convenience, one side of the cross bar is defined as the near side 34, that being the side that will be in contact with the ladder; while the other side of the crossbar is defined as the far side 36. At the location in the cross bar 12 for installation of the hook 16a, a set collar 32 (FIG. 1) is welded in place on the far side 36 (the set collar has a set screw not shown). The straight portion 17 of the hook 16a extends through the cross bar through a hole in the near side 34 opposite the set collar 32 so that the curved portion 19 is on the near side. The hooks 16a and 16b have a welded washer 38 on the hook side (approximately where the straight portion 17 ends) and an axle cap 40 at their terminal end, that is the end of the straight portion 17. Installed between the washer 38 and the near side 34 is a compression spring 42. Installed between the axle cap 40 and the far side 36 is another compression spring 44. In this construction the hook 16a is laterally fixed while the hook 16b can slide with the slide block 18 as allowed by the slots 20 and 21 in the cross bar 12. As will be appreciated and described below, it is also possible to render the hook 16a slidable in an assembly similar to that related to hook 16b (such an embodiment is described below with reference to FIGS. 25-29). In an alternative construction the spring 42 can be omitted and the washer 38 can be welded on at a point closer to the cross bar 12. Also installed on the far side 36 is a bubble level 46 at an angle appropriate to enable placement of the ladder within OSHA regulations. Use of the device is now described.

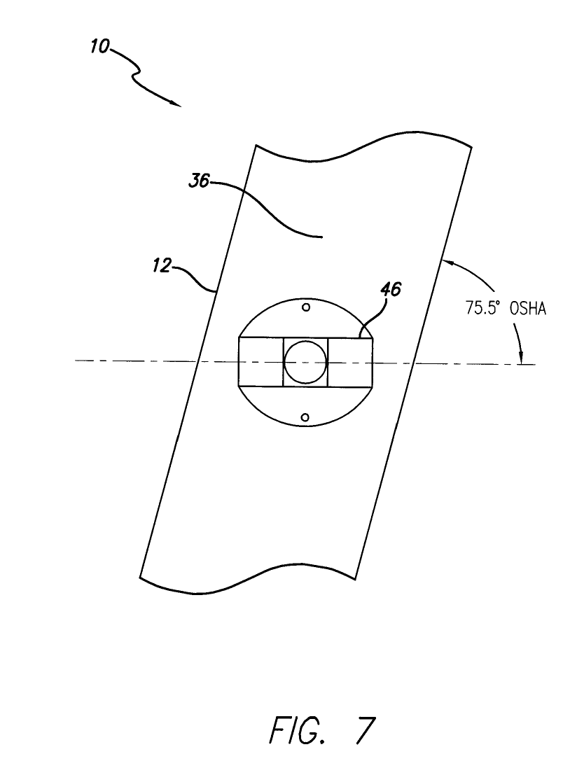

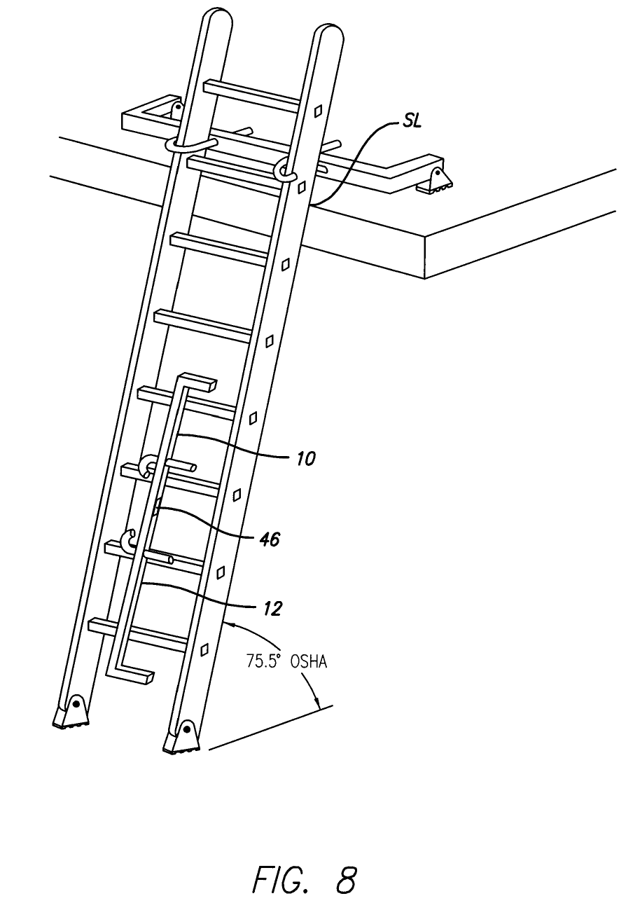

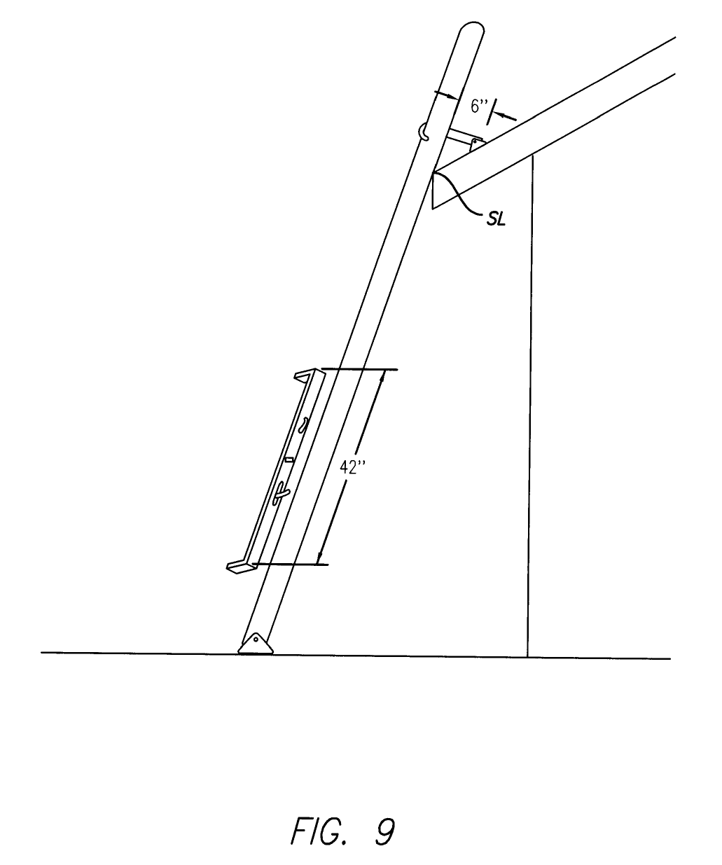

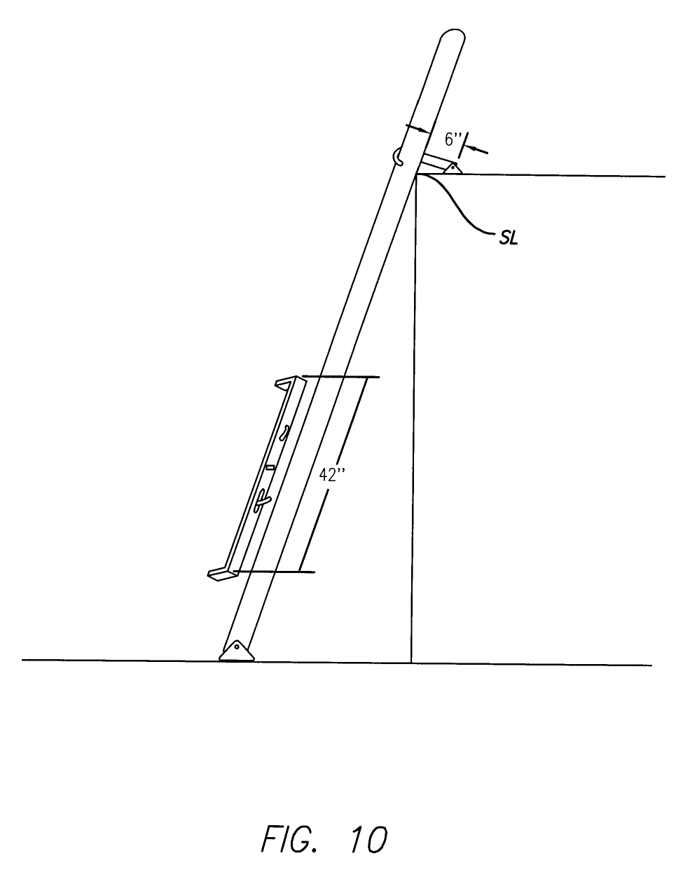

The first step is to ensure correct placement of a ladder with which the device 10 will be used. This is shown in FIGS. 7 and 8 and in which the ladder is to be set by the OSHA standard at 75.5°. To do this the device 10 is laid along the rungs of the ladder and the ladder is adjusted until the bubble level 46 shows level since it is installed at the OSHA angle on the device 10. This is also shown in FIG. 9 for a pitched roof installation, in FIG. 10 for a flat roof installation, and in FIG. 11 for a parapet wall installation.

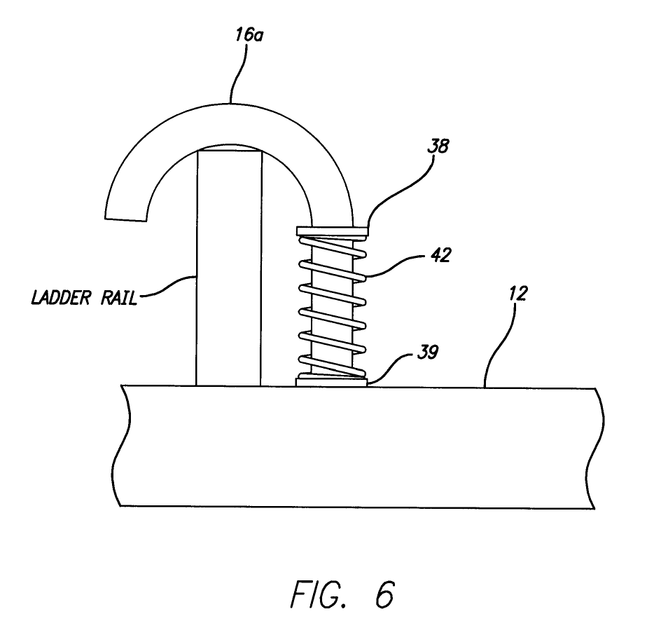

The next step is to install the device 10 on the ladder and in contact with the roof. The ladder is set up to contact the roof at a support line SL. In this regard, it is appreciated that the process of using the device is applicable to the case where a non-supported ladder leans on a support line of a structure and a portion of the ladder extends above the support line (see OSHA standards for the portion above the support line) The user will climb the ladder with the device 10 in hand. It will be placed with the cross bar 12 horizontal and the swiveling feet 15 resting on the roof as shown in FIGS. 2 and 8 for a pitched roof and in FIG. 4 for a parapet wall. The hook 16b is laterally adjusted to be closely adjacent to the ladder rail before installation, then the two hooks are put in place and final adjustments are made. Alternatively the hook 16b can be put in place on the ladder rail and the slide block 18 will self adjust (but likely with some manual assistance) to a correct position when the hook 16a is installed on its ladder rail. When the hook 16a is in place, the thumbscrew 48 is tightened against the bottom of the slide block 18 to fix it in place, although in an alternative embodiment, the thumbscrew can be omitted. The hooks 16a and 16b will be drawn forward and placed around the ladder rails. In doing this, the compression springs 44 will be compressed. When the hooks are in place on the ladder rails, they are released and the compression springs 44 will expand, pulling the device 10 in place with the near side 34 firmly against the ladder rails. Preferably the hook 16a is put in place first and then the hook 16b is put in place. FIG. 6 is a view showing the hook 16a (16b is the same but curved to the right instead of the left in the figure) in place around a ladder rail.

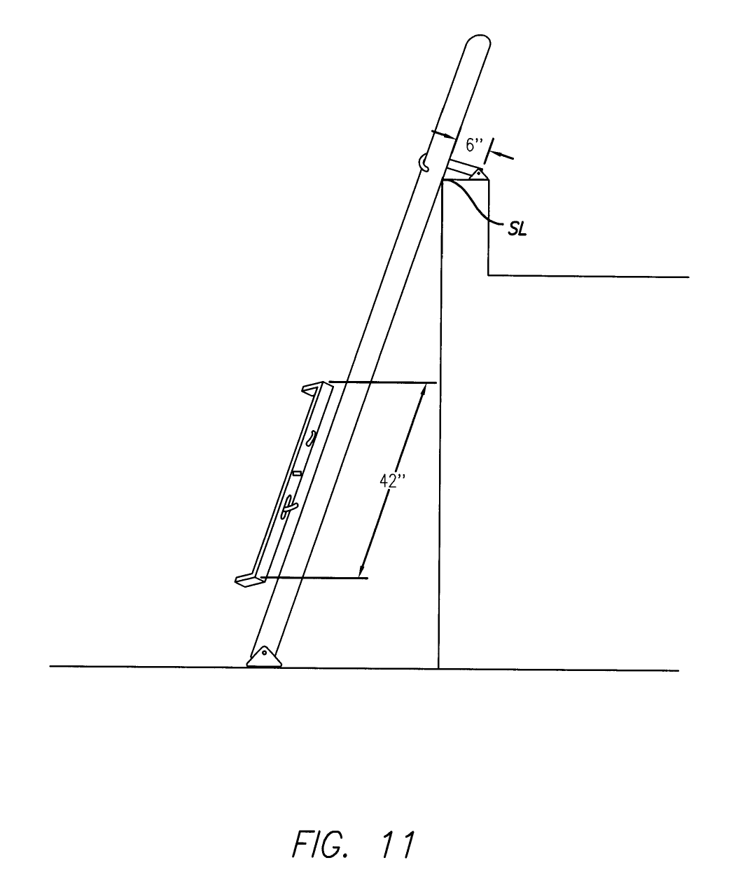

The device 10 may also be installed in a ladder set on the rake of a roof as shown in FIG. 12. In this case, the foot 15 on the lower side of the rake, the left side in the figure, is put in place normally while the foot 15 on the high side of the rake, the right side in the figure, will bear against the underside of the roof eave. The device can also be installed on a roof rake with both feet 15 in place in the normal manner, that is, both on the top of the roof.

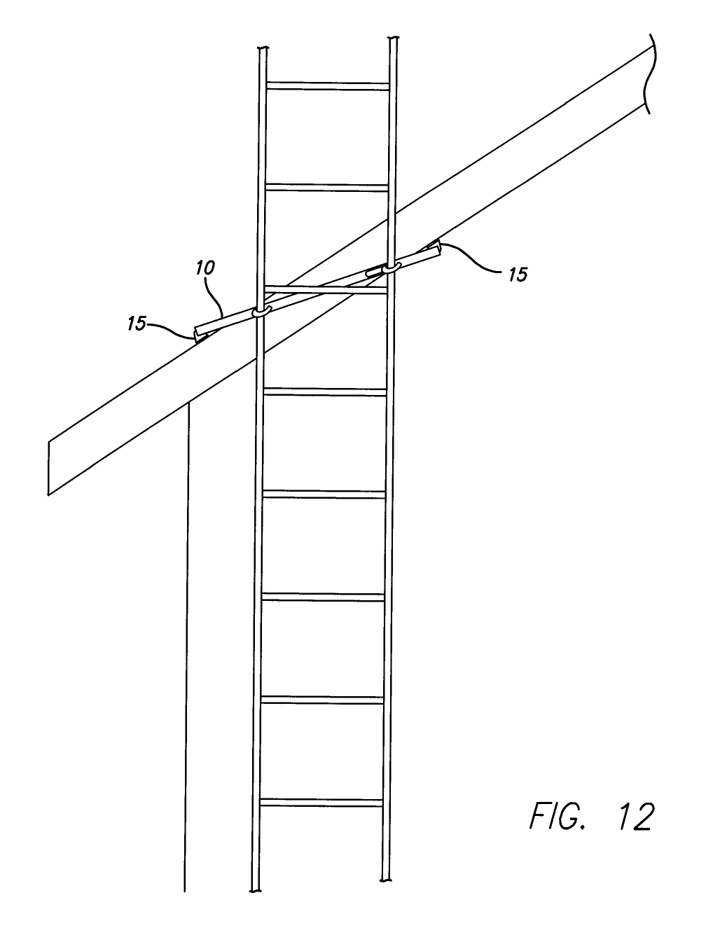

In an alternative embodiment of the invention, the legs 14 are extendable. This is shown in FIGS. 13-19C.

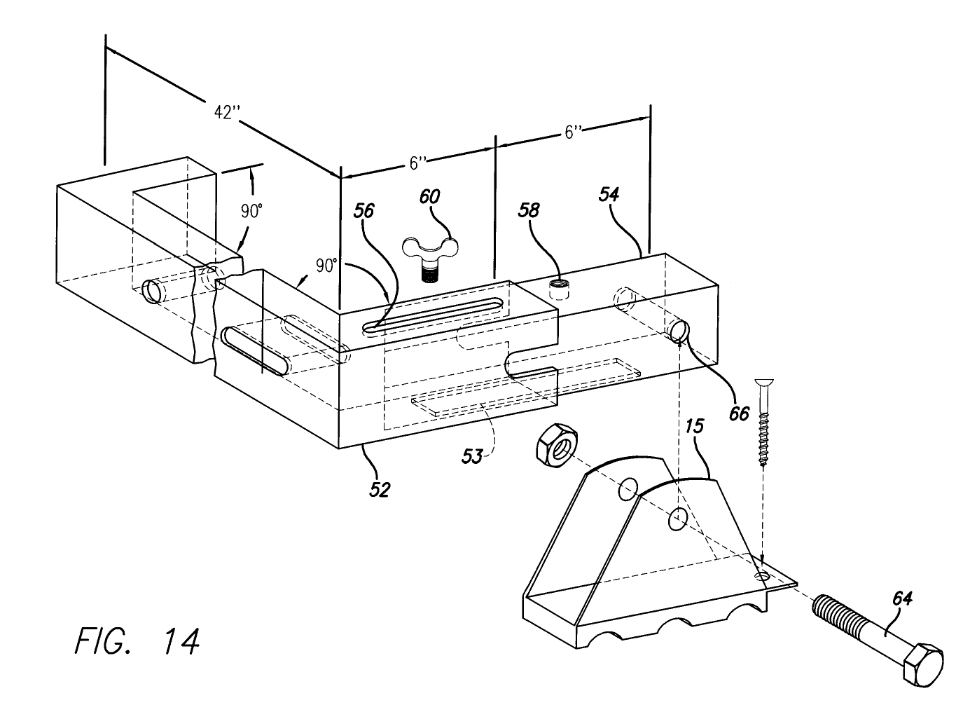

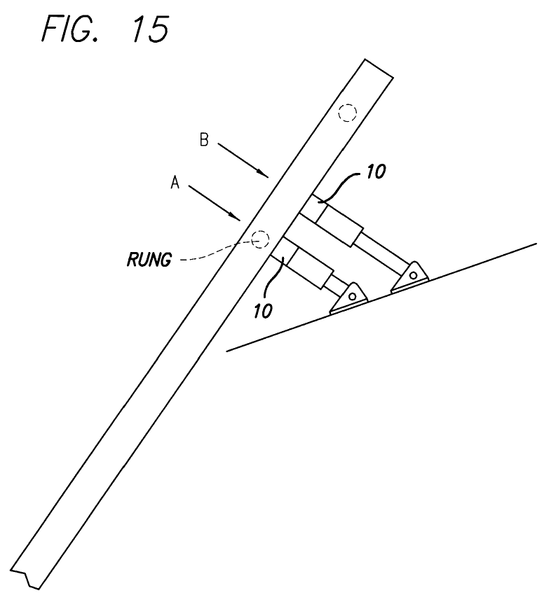

In this further embodiment the legs of the device are made extendable so that it has extended reach for the sake of reaching past extra wide gutters or to compensate for uneven roof surface where the contact on each side is not the same horizontally. In addition since the hooks that attach the unit to the outside rails of the ladder extend interiorly of the rails (that is, between the rails), in the event that a rung of the ladder is above but close to the roof line, such as 2-3 inches above the roof line, then the rung can interfere with proper placement of the hooks. To overcome this problem, the legs can be further extended which will have the effect of causing the cross bar to contact the ladder rails at a higher point thereby avoiding the undesirable interference by the rung. This will be described with reference to FIG. 15.

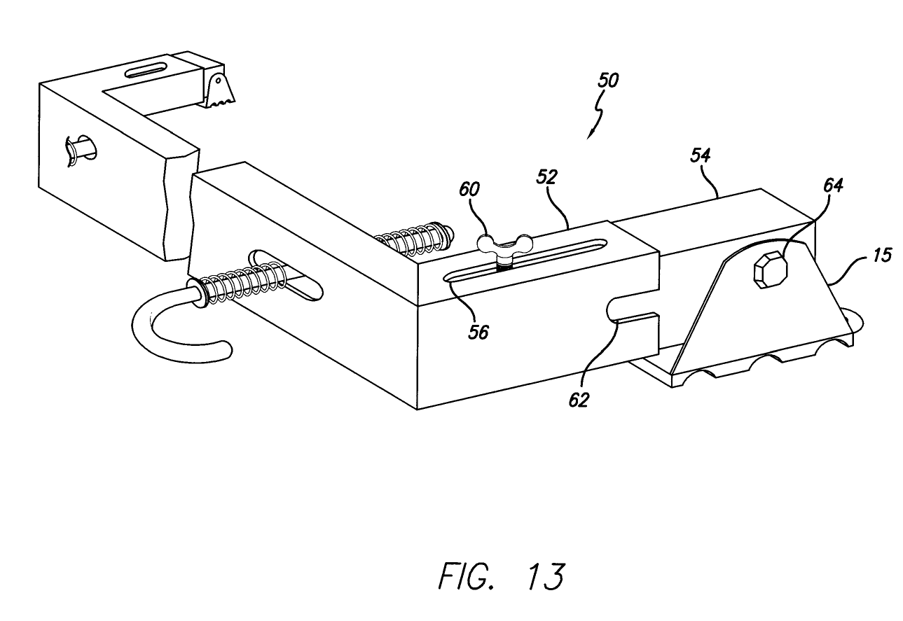

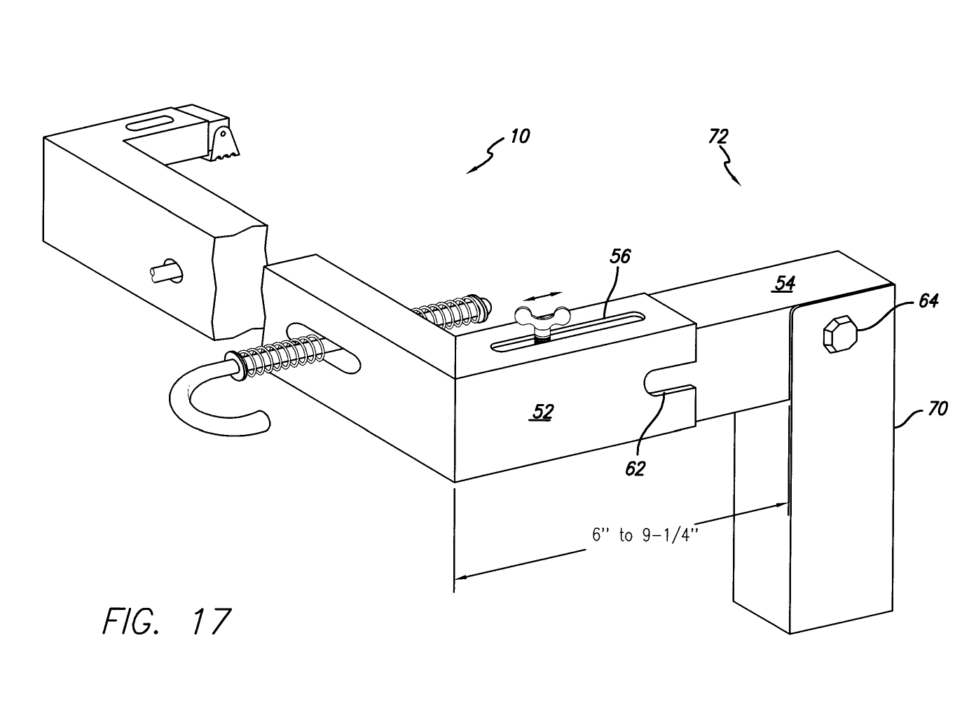

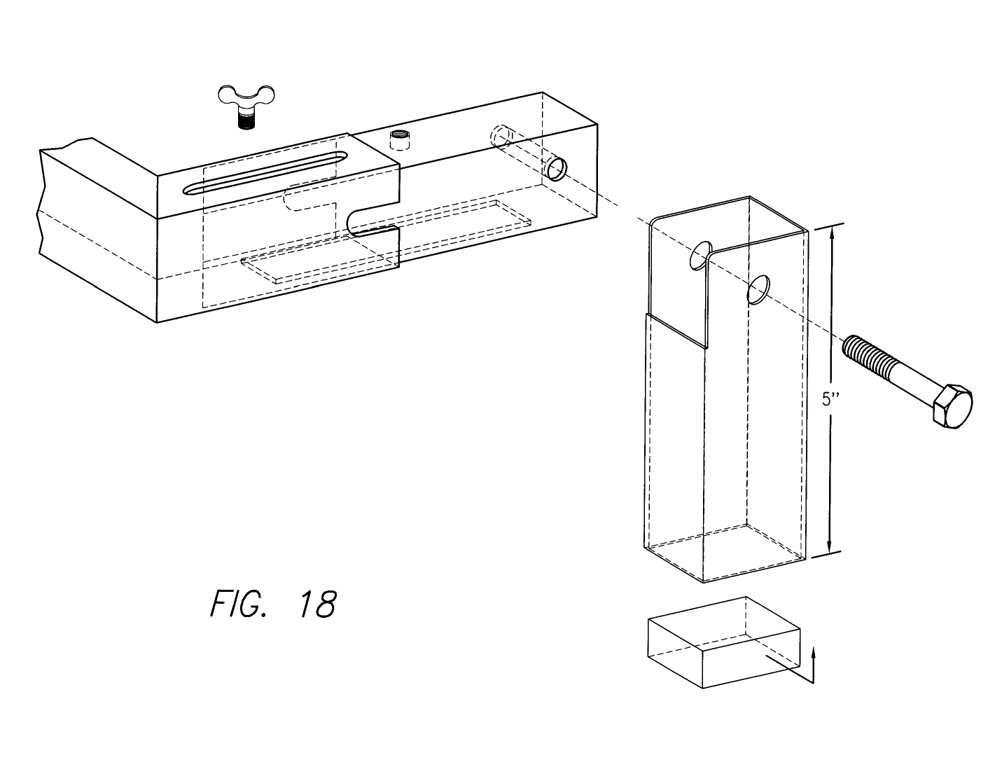

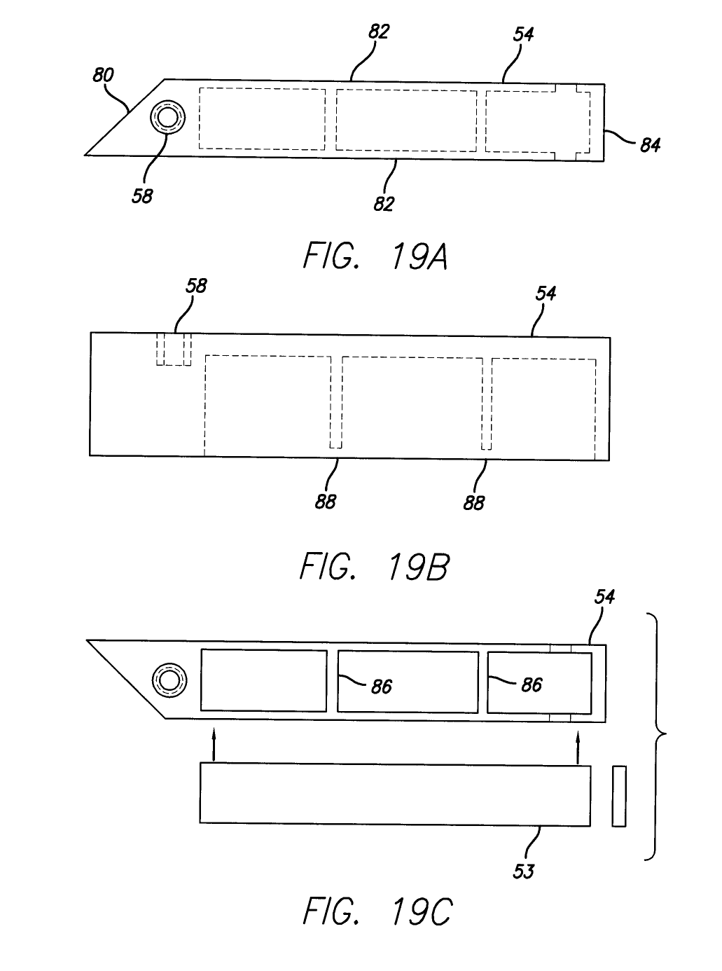

FIGS. 13 and 14 show the extendable leg structure for use on pitched roofs and flat roofs. Each extending leg assembly 50 on the opposite end of the device, is the same except that the internal slide blocks 54 are left and right handed because they have opposite miter cuts (see slide blocks in FIGS. 19A, 19B and 19C). The extending leg assembly 50 has a receiving portion 52 made of steel box and extending member 54 that slides inside the steel box 52. Swiveling ladder feet 15 are attached at the terminal ends of the extending member 54 (also called the internal slide block 54). The receiving portion 52 has a slot 56 that is adjacent a threaded insert 58 (see FIGS. 19A, 19B and 19C) in the extending member 54. A wing screw 60 extends through the slot 56 and is screwed in the threaded insert 58. A pair of slots 62 is in opposite sides of the receiving portion 52. The slots 62 are aligned with bolts 64 that extend through the swiveling ladder feet 15 and through a hole 66 in the extending member 54. When assembled, the wing screw 60 will be screwed into the threaded insert 58 through the slot 56 so as to control extension of the extending member 54 within the receiving portion 52.

In an exemplary construction the receiving portion 52 is made of 16 gauge steel box 1½ inch by 1 inch as described above with respect to the fixed leg version. The extending member 54 is made of plastic. Also, steel bar 53 (see FIG. 19C) is desirably attached to the bottom of the extending member 54; it adds strength to the plastic extending member 54 and also closes off cavities that are in the molded plastic into which a user's finger could otherwise get caught. The extending member 54 exemplary construction is shown in FIGS. 19A, 19B and 19C in which the extending member 54, made of strong plastic has a mitered end 80, and a threaded insert 58. It is made hollow with exterior walls 82, an end wall 84 and cross-walls 86 for strength. The cross walls 86 are recessed at 88 and the steel bar 53 fits into the recess as shown by the arrows in FIG. 19C

In use the extending leg assembly 50 is set by sliding the extending member 54 to a desired position and tightening the wing screw 60 to fix it. The extending member 54 can be set to its minimum position by sliding it into the receiving portion 52 while the bolt 64 slides into and contacts the end of the slot 62. The maximum extension is governed by the wing screw 60 being limited by the slot 56. An application of the extending leg structure is illustrated in FIG. 15. Position A represents the device 10 set in place such that it is close to a rung. In this position it is at least difficult and likely impossible to put the hooks in place because the rung interferes. The solution is to elongate the extending leg assembly 50 by extending the extending member 54 to make the extending leg assembly 50 longer. Then the device 10 will fit to the ladder at a different position as shown at B, now clear of any ladder rungs, so that the hooks can easily be placed on the ladder rails.

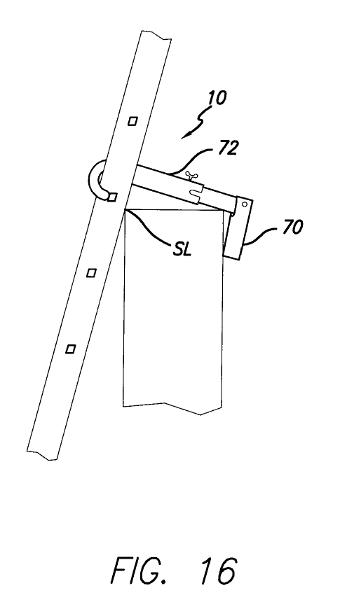

FIGS. 16, 17 and 18 show an extendable leg structure 72 for use on a parapet. It is similar to the extending leg assembly 50 shown in FIGS. 13 and 14 except that the swiveling ladder feet 15 that serve to sit on a flat or pitched roof are replaced by leg 70 set at a right angle to the internal slide block 54. It uses the same hole 66 and bolt 64 to be attached. The receiving portion 52 and the internal slide block 54 (also called the extending member 54) are the same as those described above in FIGS. 13 and 14. Although the slot 62 is still in the extending leg assembly 50, it is not used with this version.

In use with the extendable leg structure 72, as shown in FIG. 16, the device 10 is attached to the ladder as described above with the leg 70 set on the far side of the parapet wall. The ladder is supported on the support line SL.

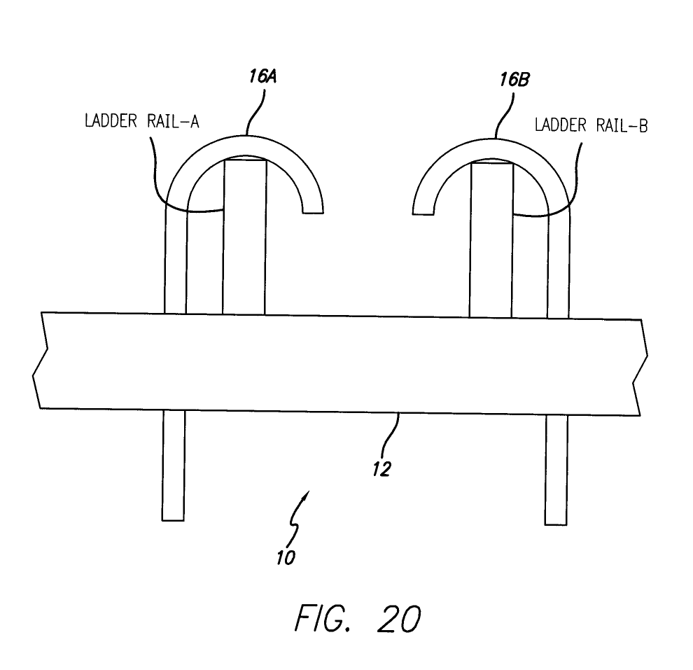

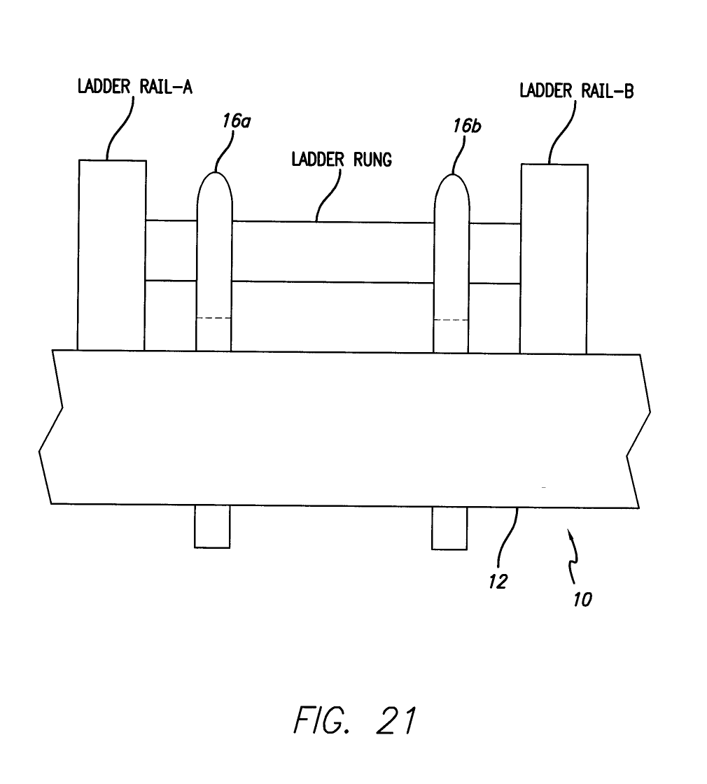

In alternative constructions, the hooks 16a and 16b can both be installed with a slide block structure as described above with respect to hook 16b; or they can both be installed without a slide block structure as described above with respect to hook 16a. In the former case it will be practical to allow attachment of the hooks to be selected from the outside of the rails as well as from the inside of the rails. Of course even with one slide block it is possible to allow attachment of the hooks from either the outside or the inside of the ladder rails by having sufficient range in the slide block. Attachment of the hooks from the outside of the rails is shown in FIG. 20, showing the device, the cross bar 12, ladder rail A and ladder rail B and hooks 16a and 16b. In FIGS. 21 and 22 there is shown the application in which the hooks 16a and 16b are secured to the ladder rung C between ladder rails A and B. Ladders are made in various widths between the rails, ranging from 11¾ inches to 22 inches. There is an OSHA standard for minimum width. In an exemplary construction, using a single slide block the hooks are spaced apart in the range from 10¼″ to 14¾″. The range of a single slide block or two slide blocks can be selected to provide any of the possible variations. Also, the size of the hook can also be selected to reach further or lesser distance from the straight portion.

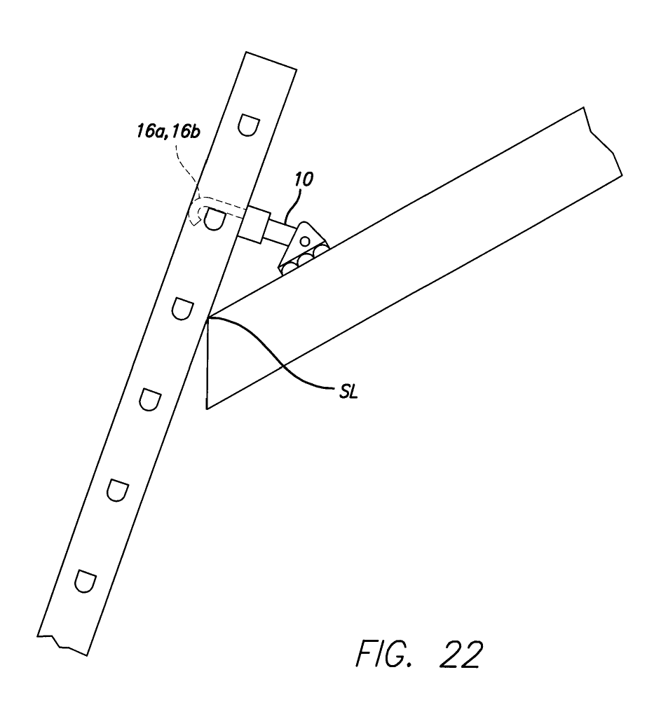

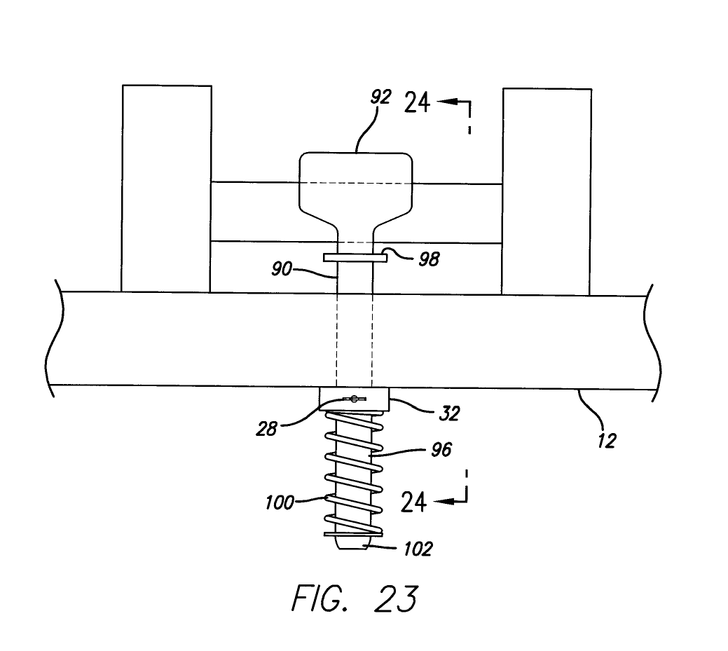

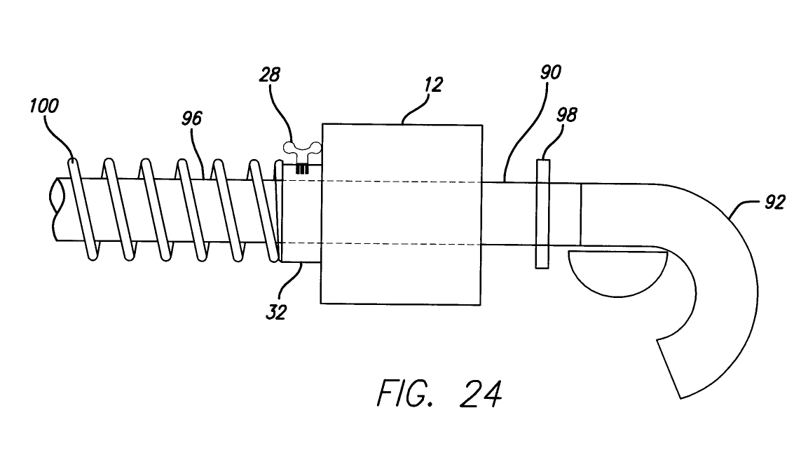

In a further alternative design, the device can employ only a single hook which would preferably be installed in the middle of the device. Preferably it would not be mounted with a slide block, although a slide block could be used. In this embodiment the hook hooks onto a ladder rung. A wide flat hook portion is desirable in this embodiment for stability. This is shown in FIGS. 23 and 24, in which the hook 90 has a hook portion 92 that is wide and a straight portion 96 extending through the cross bar 12. As described above a set collar 32 is welded to the cross bar and has a wing screw 28 for tightening when the device is in position. A washer 98 is welded to the hook, just behind the hook portion. The spring 100 is stopped with an axle cap 102.

Another embodiment of the invention will now be described with reference to FIGS. 25-29C. Much of the foregoing description is also applicable, but as will be seen there are some particulars applicable to this embodiment. One such particular, although mentioned above, is that there is a slide block for each hook, and the device is simplified in some respects as the following description will show.

As shown in FIGS. 25-28 the device 110 has a cross bar 112 and at each end of the cross bar 112 are legs 114. On each leg 114 is a foot 115. The cross bar 112 has a near side 134 and a far side 136 as previously defined (see 34 and 36 above). Spaced apart slots 120a and 120b are in the near side 134 of the cross bar 112 and aligned respectively are slots 121a and 121b in the far side 136 of the cross bar 112. These provide aligned slot pairs 120a and 121a and 120b and 121b. These are shown in the enlarged drawings 27 and 28. Inside the cross bar 112, aligned with the slot pairs are slide blocks 118 and 119. The slide blocks are provided with holes 126 and 127. A pair of hooks 116a and 116b extend through the cross bar slot pairs and the slide blocks therein. The hooks have welded washers 138a and 138b just behind their curved portions 117a and 117b, on their straight portions 119a and 119b.

When assembled, this configuration allows greater range of adjustment in the separation of the hooks than the previously described configuration that uses only one sliding hook. Also, it has been found that the hooks, when fixed onto ladder rails do not need to be held in place by the previously described thumbscrew.

A bubble level 146 is provided so that the device can, as described above, be used to measure the correct ladder angle.

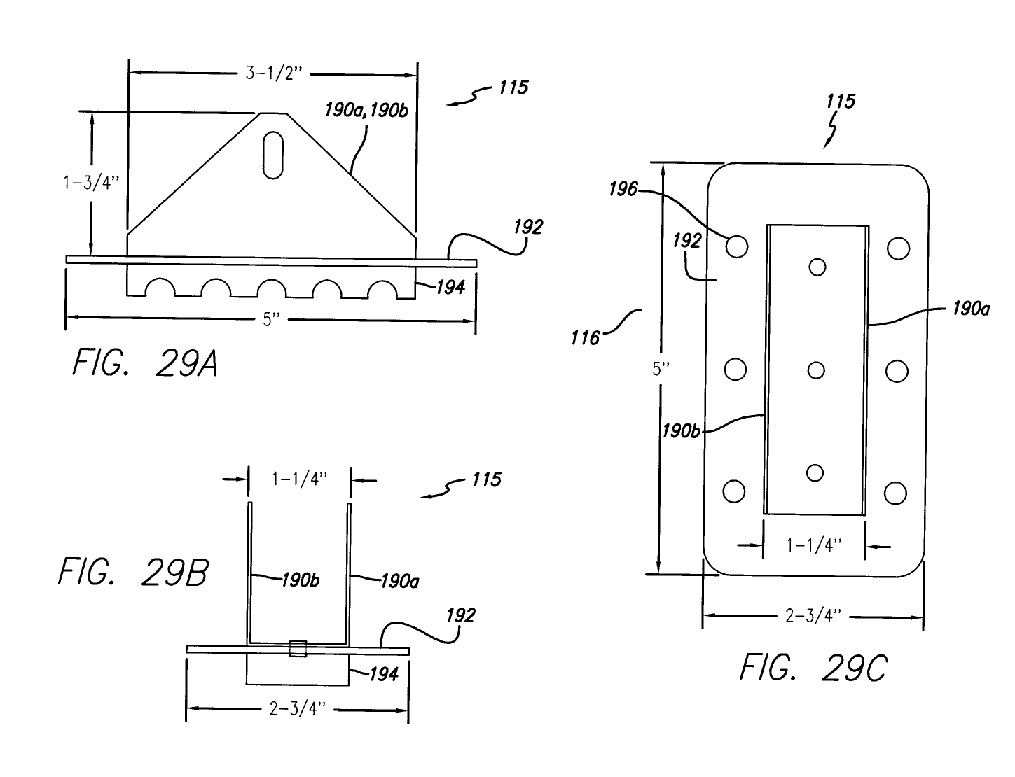

Referring to FIGS. 29A-29C, the foot 115 is detailed having upstanding flanges 190a and 190b, a base 192 and a rubber or plastic gripper 194. The base 192 is provided with holes 196 which can be used to fasten the device to a surface upon which it rests after being put into place.

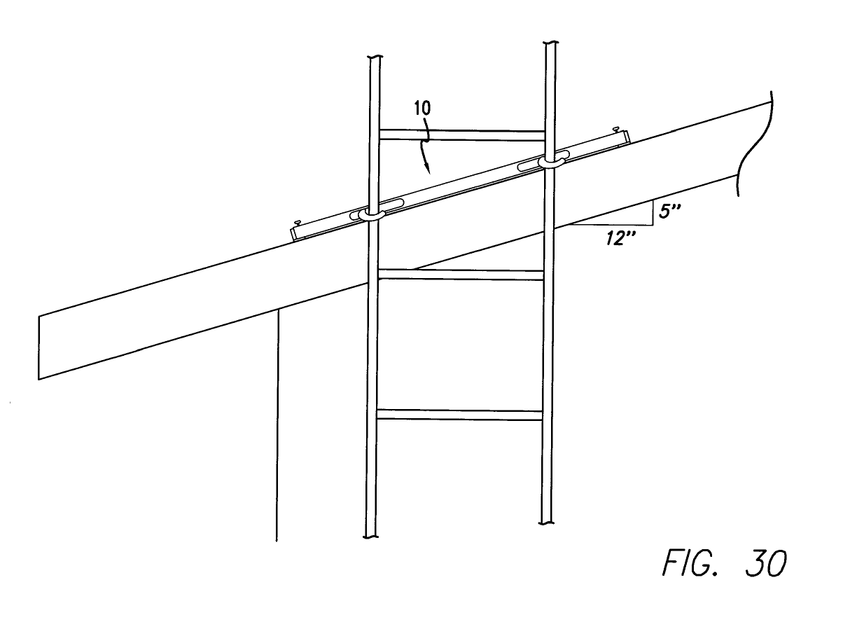

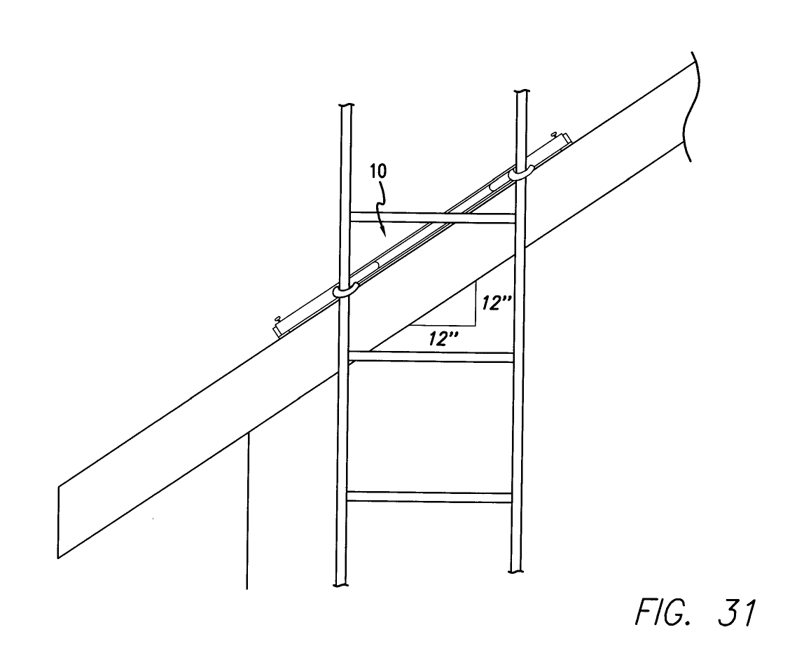

This embodiment is used as described above with the additional advantage that the range of lateral adjustment of the hooks is greater due to both hooks being fitted to slide blocks and controlled by slots. In the figures some dimensions are shown. In one particular it can be seen that the range of adjustment of the hooks ranges from a minimum separation distance of 11½ inches to a maximum of 22 inches. This range is selected to allow fitting to the full range of available ladders. Also, the greater range of adjustment allows greater range of articulation as shown in FIGS. 30 and 31.

FIGS. 30 and 31 show the increased range of articulation for use on roof rakes of different degree. FIG. 30 shows installation on a 5 by 12 rake, which is a common roof angle. FIG. 31 shows installation on a 12 by 12 rake, which is an extreme rake angle. The double slot configuration of the invention therefore allows installation in the range from a flat roof to the very extreme rack.

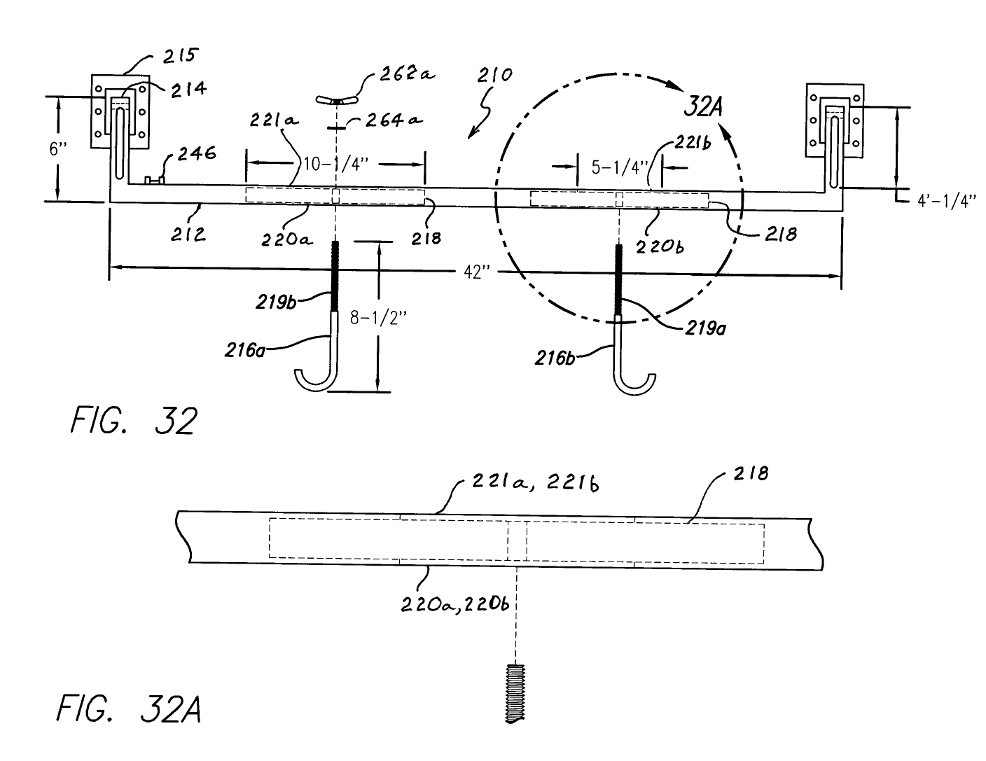

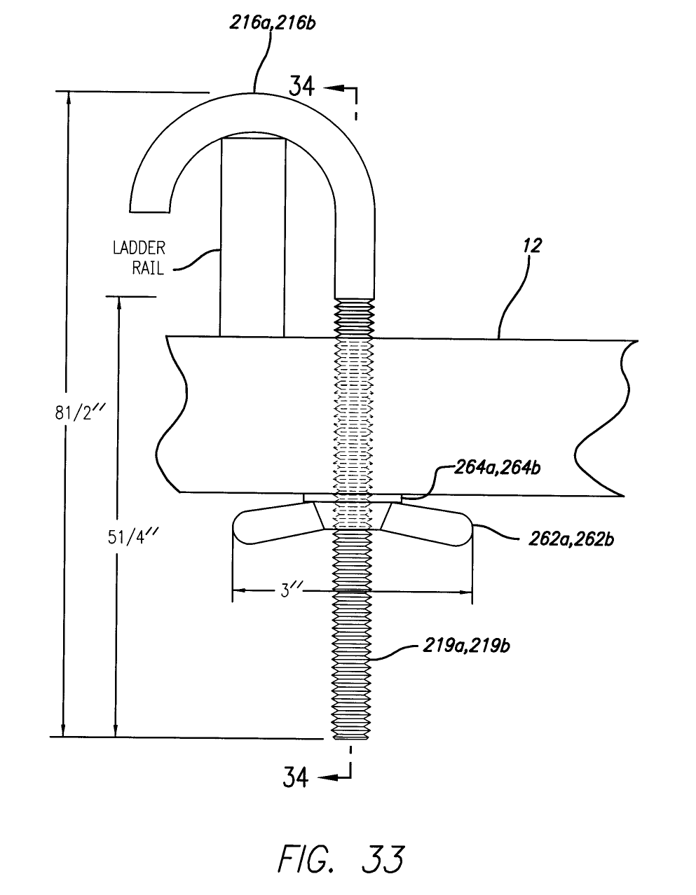

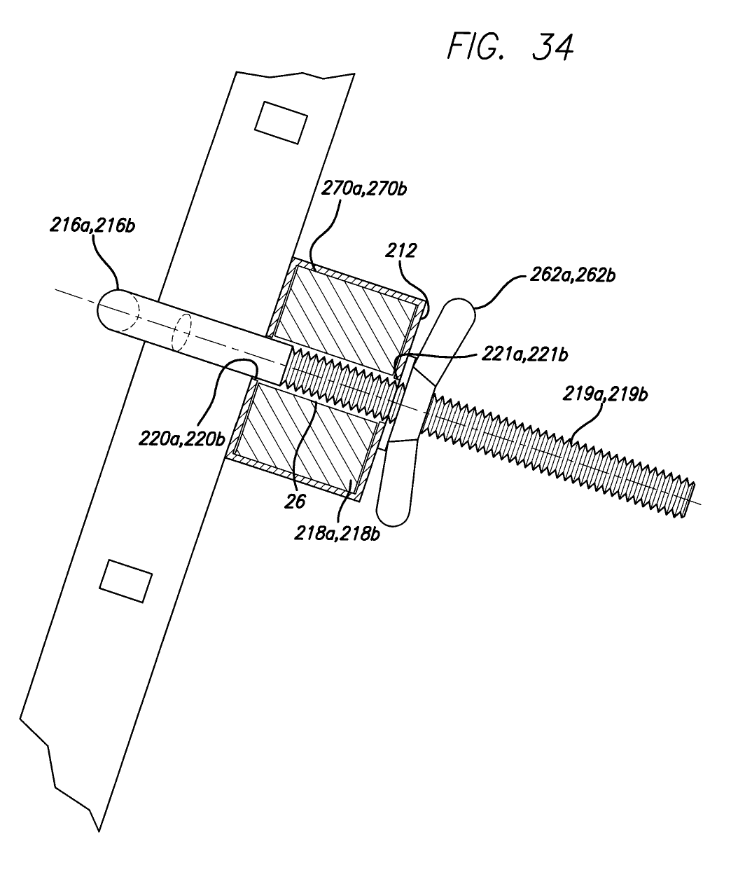

Another embodiment of the invention is shown in FIGS. 32-36. This embodiment is the same as that just described except that it has an even more simplified and more secure design. In particular, it uses the same cross bar, legs, slide blocks and slots as the previous description. The difference is that the hooks 216a and 216b are threaded along the straight portion as at 219a and 219b. The hooks are tightened on the ladder rails by wing nuts 262a and 262b, a washer 264a and 264b being used between the wing nuts and the cross bar as is common in such configurations. In use this configuration does not depend on the restoring force of the compression springs as in the prior embodiments for the force to pull and hold the ladder rails into contact with the cross bar. Instead tightening of the wing nuts provides both increased force that can be selected and controlled by the user to a fixed amount as well as being not subject to being loosened inadvertently. It has slide blocks 218 and slot pairs 220a and 221a and 220b and 221b through which the hooks 216a and 216b extend.

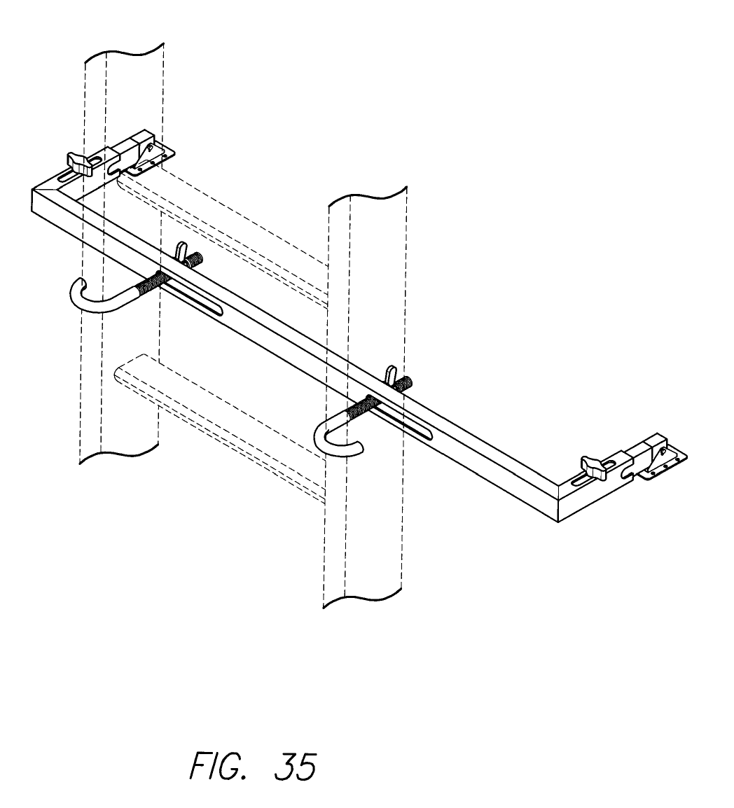

Another feature of the embodiment in which both hooks can slide along the cross bar is shown in FIG. 35. That feature is that the entire device can be slid to the left or right. This is useful when the ladder is in a position where the safety device feet would be blocked or interfered with by some structural feature of a roof such as a valley or vent or railing of a balcony. In FIG. 35 this lateral adjustability is shown by the device 10 being adjusted to the right to the extent allowed by the slots.

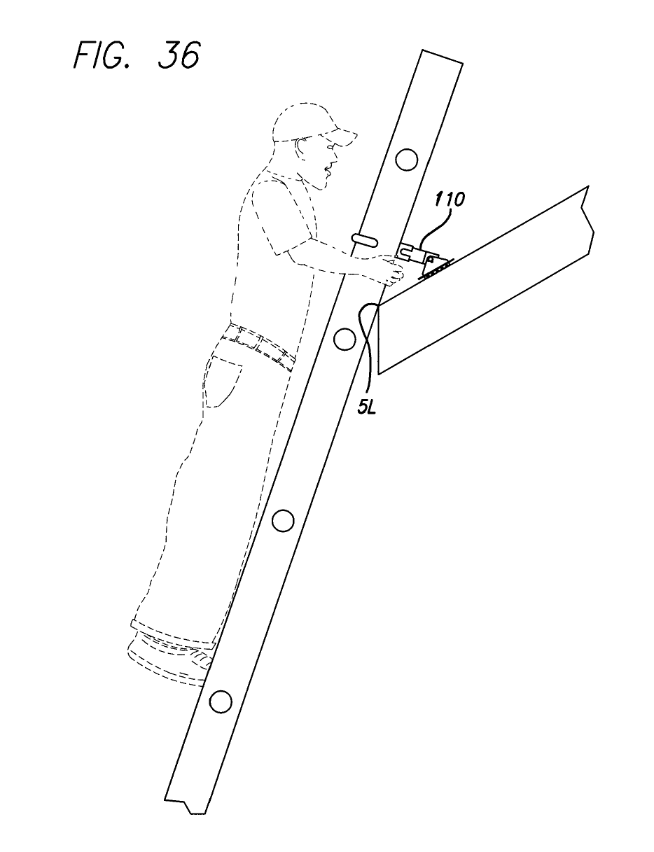

FIG. 36 shows the invention in use on a pitched roof.

In use the device is optionally available for setting the ladder angle by laying it against the rungs or a rail and adjusting the ladder to make the bubble level. Then the leg extensions should be adjusted preliminarily and not fully tightened (only enough to stay in place) based on the condition of the roof or other surface. The same is done with the slide blocks which carry the hooks. Then the device is brought up the ladder. It is laid approximately in place and the hooks set on the rail and tightened. Then the legs are extended if necessary. If the legs are of the fixed length type, the legs are first put on the surface and then the hooks fitted onto the rails. If desired the feet can be nailed or screwed to the surface.

The foregoing Detailed Description of exemplary and preferred embodiments is presented for purposes of illustration and disclosure in accordance with the requirements of the law. It is not intended to be exhaustive nor to limit the invention to the precise form or forms described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. This disclosure has been made with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising step(s) for . . . ”

1. A ladder safety device for use with a ladder leaning against a structure line having non-vertical structural portions adjacent the structure line above contact of the ladder rails comprising;
an elongated bar having a length and opposite lateral ends and defining a box interior space and having a front surface and a rear surface and being adapted to have the front surface contact the rails of a ladder when the ladder is set up;
a leg assembly extending from each end of the opposite lateral ends of the elongate member adapted to set onto the non-vertical structural portions;
a pair of hooks having a curved portion and an elongated portion passing through the elongate member the curved portion on the side of the elongate member opposite the legs and adapted to extend over either the rails or a rung of a ladder;
the elongated portion of the hooks having a fastener receiving structure that extends along at least a portion of the elongated portion;
an adjustable fastener engageable with the elongated portion of the hooks engageable with the fastener receiving structure of each hook to enable adjusting the position of the fastener along the elongated portion;
at least one slide block in sliding contact with the elongated bar, the elongated bar having a slotted formation lengthwise of a selected length;
at least one of the hooks passing from the front of the elongated bar through the slotted formation and through the slide block so that the hook and slide block can slide along the elongated bar controlled by lateral ends of the slotted formation;
whereby the elongated bar can bear against the ladder rails above the point of contact of the ladder rails against a structure line and the hooks can be applied to either the ladder rails or a ladder rung which is above the contact line of the ladder rails and by application of the fastener engageable with each hook to attach the ladder safety device to the ladder and having the leg assemblies extend over the structural portions;
whereby the ladder will be held in position against the structure line and contact of the legs to the non-vertical structure portions by downward force thereon will inhibit movement of the ladder.

2. A method of securing a ladder against a structure line so as to inhibit inadvertent movement of the ladder comprising;
providing a ladder safety device as in claim 1;
leaning a ladder against a structure line so that each rail of the ladder contacts the structure line and extends above it;
attaching the ladder safety device to the ladder above the structure line of contact of each rail by hooking the curved portion of each hook over each rail or over a ladder rung in a position that causes the leg assembly on each of the lateral opposite ends of the elongate member to extend over into contact with the non-vertical structural portions applying downward force.
tightening the hooks by use of the fasteners to cause the elongated bar to be firmly in contact with the ladder rails and at the same time to cause the legs to contact the non-vertical structural portions.

3. The method of claim 2 wherein the at least one of the hooks passing through the slide block is adjusted by lateral sliding of the slide block to cause both of the hooks to be appropriately separated to contact either the ladder rails respectively, or a ladder rung at maximum separation of the hooks and then the fasteners are used to tighten the ladder safety device onto the ladder.

4. The method of claim 3 wherein the fastener receiving structure is threads and the fasteners are nuts and by tightening the nuts the hooks are drawn towards the elongated bar trapping the ladder rails between them.

5. The method of claim 2 wherein the leg assemblies have extendable portions at an end of which is a pivotable foot having a high friction surface and wherein the high friction surface of the pivotable foot will engage the non-vertical structural portions thereby providing resistance to movement.

6. The method of claim 2 wherein the elongated bar is in the form of a closed cross section closed cross section the closed cross section having aligned front and a rear slot pairs of selected length, spaced apart a selected distance and there are two slide blocks slidably inside the elongated bar one in proximity to each slot pair and with one of the hooks passing through each slide block so that the separation of the hooks is adjustable according to the selected length of the slot pairs respectively and the safety device is mounted on a ladder by adjusting the position of the hooks to attach to the ladder rails or to a rung at the desired separation whereupon the fastener is tightened to attach the safety device to the ladder.

7. The method of claim 2 wherein the safety device has a ladder angle sensor on the elongated bar and upon placing a ladder in position the elongated bar is placed along one of the ladder rails and the ladder angle sensor will provide an output to allow the ladder to be installed at a predetermined angle.

8. The method of claim 2 wherein the leg assemblies have extension portions at an outside end of which is a downwardly angled member whereby the safety device may be mounted on a ladder which is against a parapet wall and the extension portion extends across the top of the parapet wall to a far side of the parapet wall and the downwardly angled portion engages a far side of the parapet wall so that upon tightening the fasteners, the safety device firmly grips the ladder and the parapet wall.
